(19) United States
(12) Patent Application Publication
(10) Pub. No.: US 2008/0274728 A1
(43) Pub. Date: Nov. 6, 2008

(54) INFERRING A STATE OF ACTIVITY OF A CARRIER OF A MOBILE DEVICE

(76) Inventors: Ian Bancroft Anderson, Bristol (GB); Hendrik Lambertus Muller, Bristol (GB)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/742,606

(22) Filed: May 1, 2007

(51) Int. Cl. H04Q 7/20

(52) U.S. Cl. 455/423

(57) ABSTRACT

A method of inferring a state of activity of a carrier of a mobile communication device, the method comprising
a. monitoring a parameter of a transmitter serving the mobile communication device and of a plurality of neighbouring transmitters;
b. acquiring data relating to the monitored parameter of the serving transmitter and the neighbouring transmitters during a time window;
c. processing the acquired data to generate a time window parameter associated with the time window;
d. repeating steps b and c for one or more further time windows; and
e. inferring the state of activity of the carrier of the mobile communication device from the time window parameters generated in steps b and c.

### FIELD OF THE INVENTION

The present invention relates to methods, apparatus and programs for inferring a state of activity of a carrier of a mobile communication device, and to methods, apparatus and programs for calibrating, and selecting a predetermined calibration for, an algorithm for inferring a state of activity of carrier of a mobile communication device.

### BACKGROUND OF THE INVENTION

A mobile communication device such as a cell phone that behaves in a manner reflective of a state of activity, or context, of a person carrying the device has long been a goal for the pervasive and ubiquitous research communities. Much work focusing on sensing activity in an unobtrusive manner has been carried out. One approach to sensing the activity of a cell phone or other mobile communication device uses accelerometers. This has been demonstrated as a reliable method, capable of distinguishing between various states of activity such as walking, running, remaining still and cycling. However, a limitation of this approach is that it requires additional sensor hardware which may not be present on a mobile communication device such as a cell phone.

### SUMMARY OF THE INVENTION

According to a first aspect of the invention there is provided a method of inferring a state of activity of a carrier of a mobile communication device, the method comprising:
a. monitoring a parameter of a transmitter serving the mobile communication device and of a plurality of neighbouring transmitters;
b. acquiring data relating to the monitored parameter of the serving transmitter and the neighbouring transmitters during a time window;
C. processing the acquired data to generate a time window parameter associated with the time window;
d. repeating steps b and c for one or more further time windows; and
e. inferring the state of activity of the carrier of the mobile communication device from the time window parameters generated in steps b and c.

This method uses data which is readily available to a typical mobile communication device, such as a GSM cell phone, and thus no additional hardware is required. Using this method it is possible to distinguish between various states of activity of a carrier of the device, such as walking, driving in a motor vehicle and remaining stationary.

The monitored parameter of the serving transmitter and the neighbouring transmitters may comprise a signal strength associated with each of the transmitters.

The time window parameter may comprise a total signal strength fluctuation value.

Acquiring data relating to the monitored parameter may comprise recording a signal strength value of the serving transmitter and each of the neighbouring transmitters at intervals during the time window.

Processing the data acquired during the time window may comprise recording maximum and minimum signal strength values of the serving transmitter and each of the neighbouring transmitters, calculating a transmitter signal strength fluctuation value of the serving transmitter and each of the neighbouring transmitters over the time window and calculating the total signal strength fluctuation value associated with the time window by summing the transmitter signal strength fluctuation values of the serving transmitter and the neighbouring transmitters.

Recording the maximum and minimum signal strength values may comprise comparing the signal strength value of the serving transmitter and each of the neighbouring transmitters with previously recorded maximum and minimum signal strength values of that transmitter at each interval and, if the signal strength value is greater than the previously recorded maximum signal strength value, recording the signal strength value as the maximum signal strength value, and if the signal strength value is smaller than the previously recorded minimum signal strength value, recording the signal strength value as the minimum signal strength value.

Calculating the transmitter signal strength fluctuation of the serving transmitter and each of the neighbouring transmitters over the time window may comprise subtracting the minimum signal strength value of each transmitter recorded during the time window from the maximum signal strength value of that transmitter recorded during the time window.

The monitored parameter of the serving transmitter and the neighbouring transmitters may comprise an identifier associated with each transmitter.

Acquiring data related to the monitored parameter may comprise updating a list of a predetermined number of identifiers associated with candidate transmitters, the candidate transmitters being selected on the basis of their signal strength.

Processing the acquired data may comprise calculating the number of separate identifiers which appear on the list during the time window.

According to a further aspect of the invention, there is provided an apparatus comprising processor system configured to perform the method defined in the preceding paragraphs.

According to a further aspect of the invention, there is provided a mobile communication device comprising an apparatus according the preceding paragraphs.

According to a further aspect of the invention, there is provided a program for causing a processor system to perform the method defined in the preceding paragraphs.

According to a further aspect of the invention, there is provided a method of calibrating an algorithm for inferring a state of activity of a carrier of a mobile communication device, the method comprising
a. collecting data relating to a time window parameter associated with a transmitter serving the mobile communication device and a plurality of neighbouring transmitters;
b. grouping the collected data into a plurality of sets, each set reflecting a different state of activity;
c. calculating a mean for each set; and
d. using the calculated means to calibrate the algorithm.

The collected data may be grouped automatically into the plurality of sets.

The method may comprise collecting information relating to a state of activity of the carrier of the mobile communication device during collection of the data relating to the time window parameter, wherein the collected data are grouped according to the information so collected.

The information relating to the state of activity of the carrier may comprise the movement speed of the carrier, each state of activity being associated with a range of movement speeds.

The information relating to the state of activity of the carrier may comprise an identifier associated with the serving transmitter or the plurality of neighbouring transmitters.

The time window parameter may comprise a total signal strength fluctuation of the serving cell and the neighbouring cells during a time window.

The time window parameter may comprise a number indicative of the number of separate transmitter identifiers appearing on a list maintained by the mobile communication device during a time window.

The method may further comprise collecting data relating to a further time window parameter associated with the serving transmitter and the plurality of neighbouring transmitters.

The further time window parameter may comprise a number indicative of the number of separate transmitter identifiers appearing on a list maintained by the mobile communication device during a time window.

According to a further aspect of the invention there is provided an apparatus comprising a processor system configured to perform the calibration method defined in the preceding paragraphs.

According to a further aspect of the invention there is provided a mobile telephone comprising an apparatus according to the preceding paragraph.

According to a further aspect of the invention there is provided a program for causing a processor system to perform the calibration method defined in the preceding paragraphs.

According to a further aspect of the invention there is provided a method of selecting a calibration setting for calibrating an algorithm for inferring a state of activity of a carrier of a mobile communication device, the selection method comprising observing a parameter of a transmitter serving a mobile communication device over a time window and using the parameter so observed to select a calibration setting from a pre-populated list of calibrations settings.

The method may further comprising inferring from the observed parameter an environment type and selecting a calibration setting appropriate to the environment type from the pre-populated list of calibration settings.

The observed parameter may comprise an identifier indicative of the environment type.

### BRIEF DESCRIPTION OF THE DRAWINGS

An embodiments of the invention will now be described, strictly by way of example only, with reference to the accompanying drawings, in which:

FIG. 1a illustrates the total number of identifiers associated with cells monitored by a GSM cell phone for different states of activity;

FIG. 1b illustrates the total received signal strength fluctuation of a serving cell and neighbouring cells monitored by a GSM cell phone for different states of activity;

FIG. 2a shows the mean number of individual cells monitored by a GSM cell phone during a number of time windows plotted against the mean total received signal strength fluctuation of a serving cell and neighbouring cells monitored by the GSM cell phone during the time windows; and

FIG. 2b shows the graph of FIG. 2a in which the measurement space has been divided according to states of activity.

### DETAILED DESCRIPTION OF AN EMBODIMENT

The Global System for Mobile Telecommunications (GSM) is currently the most popular cellular network standard, with over a billion users worldwide. In the US and Canada, GSM networks typically operate in the 850 MHz and 1900 MHz bands, whilst elsewhere the 900 MHz and 1800 MHz bands are typically used. Channels are spaced throughout these bands at 200 KHz intervals creating 124 separate channels. On each of these channels GSM networks operate a Time-Division Multiple Access (TDMA) system enabling multiple mobile stations to share the same channel. A cell is allocated a number of channels depending on the predicted usage for the area that it serves. Usage is estimated based on radio surveys and the expected customer base for that area. Once a usage model has been constructed a network designer selects the number and types of cell required to provide coverage for the area. In dense urban environments a high number of micro (short-range) cells are used, thus increasing network capacity. In contrast, service in rural areas is provisioned by macro cells with a coverage range of up to 35 km.

In order to provide support for roaming, a mobile communication device, such as a GSM cell phone, monitors the cell currently serving it and a number, typically six or seven, of neighbouring cells, and maintains a list of the monitored cells. When the mobile communication device is stationary, this list typically varies only minimally, in that only a limited number of individual cells (perhaps seven or eight, for example) appear on the list during a given time period.

However, when the mobile communication device is moving, the list of monitored cells changes, particularly in metropolitan environments with a large number of cells, such that a larger number of individual cells (perhaps ten or more, for example) appear on the list during a given time period. When a large geographic area is covered the number of cells monitored increases. The precise number of cells monitored depends on both the type of environment and the speed of the carrier of the mobile communication device. In metropolitan environments, for example, there is typically a high number of micro cells, whereas rural environments with lower populations typically require only a few macro-cells. In a given environment, a specific increase in the number of cells is observed as the speed of movement of the carrier of the mobile communication device increases.

Hence a change in the list of monitored neighbouring cells typically indicates a change in the position of the mobile communication device.

One of the parameters monitored by the mobile communication device is the strength of signals received from base transceiver (transmitter-receiver) stations (BTS) associated with the serving cell and the neighbouring cells. When the mobile communication device is stationary, there is typically only a small amount of variation in the strength of these received signals during a given time period. In contrast, when the mobile communication device is moving, the strength of the received signals is subject to a larger degree of variation during a given time period.

Thus, variations in the received signal strength are typically indicative of movement of the mobile communication device.

The use of these monitored parameters to infer a state of activity of a carrier of a mobile communication device will now be described in more detail.

In order to maintain mobile-to-base station communication whilst a mobile communication device is moving, a cellular network must provide support for migrating service provision to the mobile device from one cell to another. This process, referred to as ‘handoff’, typically occurs when a signal level and a received power level on the mobile communication device drop below a predetermined threshold. To provide support for this behaviour, the mobile communication device maintains a list of typically six or seven neighbouring cell signal strength levels.

The mobile communication device monitors signal power levels of the BTS which is currently serving it (also referred to as the ‘current cell’), and of BTSs associated with neighbouring cells. In order to identify these neighbouring cells, the mobile communication device can use a Broadcast Common Control Channel (BCCH) on the serving BTS. The purpose of the BCCH is to transmit system information, including a list of neighbouring cells, known as a ‘BA list’, that the mobile communication device can expect to detect, given that the mobile communication device has an active connection with the serving BTS.

When a BTS is in a passive state (i.e. when the BTS is not actively managing a mobile communication device), the BCCH is used to send system information messages. In a GSM system, a set of predefined system information messages (called SYS_INFO) are provided. Thus, in a passive state, the serving BTS transmits message 2 from the predefined set of SYS_INFO messages. This message provides the mobile communication device with a description of the neighbouring cells. The description is made up of a list of channels that the mobile station could potentially use to receive a better signal power. The neighbouring cells in the list are represented using Absolute Radio Frequency Channel Numbers (ARFCN). An ARFCN is an identifier for a channel used by the air interface in a cellular system.

When a BTS is in an active state (i.e. when it is actively managing one or more mobile communication device), a different message, number 6 in the predefined SYS_INFO message set, is used, providing equivalent behaviour.

While the mobile communication device is idle, it scans the BCCH for neighbouring cell information. This initially produces a list of up to 16 ARFCNs (representing 16 neighbouring cells, each with an associated BTS). The mobile communication device reduces this initial list of identifiers to a list of a predetermined number of identifiers, typically six, of the best candidates for handover, on the basis of the received signal strength associated with their BTS.

As was mentioned above, when the mobile communication device is stationary, the list of candidates does not vary to a great extent during a given time window, whilst when the mobile communication device is moving, there is a greater degree of variation of the candidate list over a given time window. Similarly, the received signal strengths (often expressed in terms of power) associated with the serving BTS and with each of the candidate cells in the list do not vary greatly during a given time window, but are subject to a greater degree of variation when the mobile communication device is moving.

Experimental data confirms this behaviour. An experiment was carried out in which GSM trace data was collected when volunteers were in indoor and outdoor settings in metropolitan environments. The volunteers were equipped with Orange SPV C500 cell phones capable of monitoring the signal strength levels for the current serving cell and up to six neighbouring cells. When the volunteers were outdoors, GPS receivers were used to collect a ground truth for the monitored parameters. Samples of the monitored parameters were collected once per second.

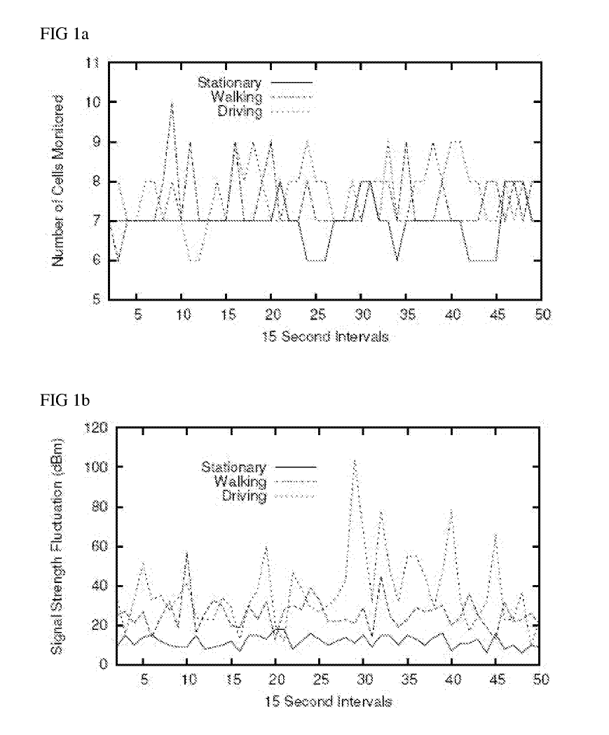

FIGS. 1a and 1b illustrate the results of this experiment. FIG. 1a shows the total number of identifiers (i.e. ARFCNs) associated with cells appearing in the list of candidates during a rolling 15 second time window, for the activity states stationary, walking and travelling in a motor car. In the stationary activity state, typically only six or seven identifiers appeared in the list of candidate. Typically, more identifiers appeared in the lost of candidates in the walking and travelling in a motor car states of activity, and both of these states of activity shared similar patterns. It is thought that although a greater distance was covered in the motor car than when walking, the number of identifiers appearing in the candidate list was similar for both of these states of activity because of a hardware limitation of the cell phone used to collect the data and the need to avoid repeated changing of the neighbouring cells (thrashing). Hence moving at a slower speed through a metropolitan environment gives the cell phone more opportunity to detect and assess the suitability of neighbouring cells.

FIG. 1b shows a total signal strength fluctuation of the signals received from the serving BTS and the BTSs associated with the identifiers appearing in the list of candidates by the cell phone used in the experiment during a rolling 15 second time window. The method used to calculate the total signal strength fluctuation comprised measuring the received signal strength from the serving BTS and from each of the BTSs appearing in the list of candidates at one second intervals during the time window, calculating a signal strength fluctuation value for each BTS by subtracting the minimum signal strength received during the time window from the maximum signal strength received during the time window, and summing the BTS signal strength fluctuations. This method was performed by an algorithm running on the cell phones used by the volunteers, which is represented by the following pseudo-code.
Set a short time interval (SAMPLE_PERIOD) (in this example 1 second).
Set a longer time interval defining the time window size, i.e. the number of samples to assess together (WINDOW_PERIOD) (in this example 15 seconds).
Every SAMPLE_PERIOD, perform the following steps:
   Record the signal strength levels for all of the BTSs that are currently being monitored (neighbouring and serving);
   For each BTS compare the new signal strength level with the minimum and maximum signal strength levels previously recorded for that BTS;
   If the new signal strength level is greater than the previous maximum then
      Set the maximum signal strength level to the new signal strength level;
   If the new signal strength level is less than the previous minimum then
      Set the minimum signal strength level to the new signal strength level.
   (It will be understood that if a BTS only appears on the list of candidates only once then the signal strength fluctuation for that BTS will be zero).
Every WINDOW_PERIOD, perform the following steps:
   For each BTS, calculate the amount of signal strength fluctuation by subtracting the minimum signal strength level that was observed during the WINDOW_PERIOD from the maximum signal strength level that was observed during the same WINDOW_PERIOD.
   Add these individual levels of signal strength fluctuation to produce a single number representing the overall level of signal strength fluctuation for the given WINDOW_PERIOD.

FIG. 1b shows that it is relatively easy to distinguish between the walking and stationary states of activity by analysing signal strength fluctuation alone. However, at times, the walking and travelling in a motor car states of activity share similar signal strength patterns. By comparing the fluctuation with GPS traces from the GPS receivers used by the volunteers, it was found that the drops between high spikes of fluctuation typically occurred while waiting at areas of traffic control or road junctions. Hence the graph of FIG. 1b reflects the stop-start nature of driving in metropolitan environments. While travelling in a motor car at constant but low speeds (typically below 30 mph), the signal strength fluctuation patterns were found to be similar to those obtained while walking. This reflects the speed of travel, but does not represent the mode of travel.

Thus, data received by a mobile communication device such as a GSM cell phone can be processed and used to infer a state of activity of a person carrying the mobile communication device.

As explained above, it is it is relatively easy to distinguish between the walking and stationary states of activity, and thus to infer the state of activity of a carrier of a mobile communication device, by analysing signal strength fluctuation or the number of BTS identifiers appearing in the list of candidates. However it is difficult to distinguish between the walking and travelling in a motor car states of activity by analysing these parameters alone. Machine learning techniques can be used to alleviate this problem, by classifying patterns of signal strength fluctuation or of candidate list variation as occurring while the carrier of the mobile communication device is in specific states of activity.

In one embodiment, an artificial neural network (ANN) can be used to analyse one or more parameters associated with a BTS serving a mobile device and with a plurality of neighbouring BTSs, such as those appearing on the list of candidates maintained by the mobile communication device, to infer the state of activity of the carrier of the mobile communication device. In one example, inputs to the ANN are: (i) the sum of signal strength fluctuation across the serving BTS and neighbouring BTSs (as defined above) during a time window and (ii) the number of separate BTSs monitored (i.e. appearing on the list of candidates) during the time window. The ANN outputs the current state of activity for the given input values. The ANN uses a single layer of eight hidden units. Weights are learnt using back propagation.

In tests, the ANN was trained by repeatedly presenting data collected during each state of activity. It was found that once trained the ANN performs well, in that it is able to distinguish between different states of activity.

The table below shows a confusion matrix for sensing the state of activity of a carrier of a mobile communication device. Each row of the table indicates the state of activity of the carrier of the mobile communication device, whilst each column indicates the state indicated by output of the ANN.

| | Stationary | Walking | Travelling (car) |
|---|---|---|---|
| Stationary | 90% | 10% | 0% |
| Walking | 15% | 79% | 6% |
| Travelling (car) | 11% | 54% | 36% |

A total of three hours of trace data was used to evaluate performance. Ten minutes of this data was used for training the neural network and the remainder for testing. It is clear that distinguishing between the stationary state of activity and other states of activity produces good performance, only occasionally incorrectly positioning the carrier as walking. Similarly, when the carrier was walking good performance levels were achieved.

However, travelling in a motor car resulted in the ANN incorrectly placing the state of activity as walking in a large number of cases. This was expected, as the pattern of signal strength fluctuation whilst the carrier was in the travelling in a motor car activity state was erratic, in that periods of high fluctuation were found between periods of low fluctuation. These drops were similar to those found whilst the carrier was in the walking activity state and, on occasion, in the stationary activity state.

This is due to the ANN effectively outputting a speed of travel that has been mapped to a state of activity via the training data. Typically, the greater the fluctuation in signal strength levels and variation in the list of candidate BTSS, the greater the speed. However, whilst travelling in a motor car the speed of travel fluctuates between stationary (for example whilst waiting at traffic lights), walking speed (driving in conditions of traffic congestion), and normal (clear roads). This results in the network occasionally indicating other states of activity. This issue can be addressed by refining the ANN to include additional information about the task being sensed. For example, changes to the state of activity that occur for short periods of time can be removed by using the knowledge that a typical car journey is not ended and a new one started in a 15-second time period. Hence short periods of low signal strength fluctuation can be ignored when placed between periods of high fluctuation.

The results of this task-based approach are shown in the table below.

| | Stationary | Walking | Travelling (car) |
|---|---|---|---|
| Stationary | 96% | 4% | 0% |
| Walking | 3% | 91% | 6% |
| Travelling (car) | 5% | 15% | 80% |

This shows that by complementing the output of the ANN with information about the task to be sensed it is possible accurately to determine the state of activity of the carrier of the mobile communication device. This addresses the issues of placing the carrier in different states of activity whilst travelling in a motor car. A performance increase is also gained when sensing walking and remaining stationary.

Whilst this approach can be used reliably to distinguish between different states of activity, it suffers from two limitations.

Firstly, in order to calibrate the mobile communication device for use in a given environment the ANN needs to be trained. Training is computationally expensive and hence not suitable for running directly on a mobile communication device such as a cell phone. In addition, in order for an ANN to be trained, a collection of data points with a ground truth must be provided. Collecting this data is an arduous task.

The second limitation is that once trained, the ANN only operates well in one particular environment, for example a metropolitan environment. Performance quickly degrades as the carrier of the mobile communication device moves into a different environment. Tests having been carried out using a trained ANN network in a variety of metropolitan environments, and have shown positive results. However, when testing in environments with different cellular network structures, such as rural locations, the ANN was found to need retraining. For example, signal strength fluctuation is not as apparent in rural areas, hence using the same ANN for both metropolitan and rural areas may result in walking being detected as remaining stationary, for example. This can be addressed by adjusting the sensitivity of the ANN in accordance with the current environment.

These limitations can be mitigated by calibrating the mobile communication device in an unsupervised (automated) manner. In one embodiment, the ANN can be replaced with a Hidden Markov Model (HMM). This allows the previous state of activity of the carrier to be contained in the model and hence better predictions of the current state of activity can be made.

In the method discussed above, the state of activity of a carrier of a mobile communication device such as a GSM cell phone can be inferred from observations of monitored parameters of the serving BTS and neighbouring BTSs. The monitored parameters provide an indication of the state of activity, but this needs to be smoothed out by knowledge of “normal” behaviour. For example, it is usual for a person to drive for a prolonged period of time, and then to walk; it is unusual for a person to switch between driving and sitting frequently. This activity can be modelled using a Hidden Markov Model (HMM).

A HMM λ is defined as follows:

λ=(A,B,π)

A is a transition matrix representing the probabilities of moving from one state of activity to another. In the context of HMMs, the state of activity of a cell phone carrier is referred to by the term “state”, that is, the hidden non-observable state. Therefore the term “state” will be used to refer to carrier's activity. B is an observation matrix representing the probability of being in a state given an observation, and π is an initial probability distribution.

S represents a set of states that the carrier can be in (the “state alphabet”). In this example,

S=(stationary,walking,travelling in a motor car)

V is a set of discrete observations. It comprises n elements (v₁, v₂, . . . , vₙ). In this example, measurements of the signal strength fluctuation and the candidate list variation are mapped onto a set of 15 discrete observations. This process is described in detail below.

During operation of the HMM a sequence of observations will lead to a sequence of states. There are t observations O, and t matching inferred states Q:

O=(o₁,o₂, . . . ,oₜ)Q=(q₁,q₂, . . . ,qₜ)

The strength of a Hidden Markov Model is that it uses knowledge of previous states in order to predict the most probable current state. In this example, five prior states are remembered, and this is represented in the transition matrix A. Hence, the probability of qₜ depends on states (qₜ₋₅, qₜ₋₄, . . . ,qₜ₋₁):

P(qₜ|q₁_{^{t-1}})=P(qₜ|qₜ₋₅,qₜ₋₄, . . . , qₜ₋₁)

The matrix A captures these probabilities: it contains the probability of transitioning to state j given the previous five states of activity in a sequence, qₜ₋₅, qₜ₋₄, . . . ,qₜ₋₁, that is:

aᵢⱼ=P(qₜ=Sᵢ|qₜ₋₅,qₜ₋₄, . . . , qₜ₋₁)

where qₜ is the future state in a sequence. The observation matrix B contains the probabilities of an observation k being produced whilst currently in state j:

bⱼₖ=(Vₖ|Sⱼ)

In order to infer the most likely state sequence given a sequence of observations the Viterbi algorithm can be used, which will be familiar to those operating in this field.

As with the ANN embodiment described above, problems can occur with the HMM method when moving from, for example, a metropolitan environment to a rural environment, because the same level of cell fluctuation will correspond to different states of activity in these environments.

In order to alleviate these problems, a set of calibration settings for the alogorithms used to infer the state of activity of the carrier of the mobile communication device can be created, with each calibration setting in the set corresponding to a particular type of environment. The set of calibration settings can be used to populate a list, such as a look up table, which may be stored locally on the mobile communication device, or which may be stored remotely, for example on a server, to be accessed by the mobile communication device when required. In a simple example, a look-up table may comprise a pre-populated list of two calibration settings, one corresponding to a metropolitan environment and the other corresponding to a rural environment.

In one method, a calibration setting can be created on an unsupervised (i.e. automated) basis. This method uses the HMM described above. The Baum-Welch method, which will be familiar to those well-versed in this field, is used to learn A, B, and π. By presenting the Baum-Welch algorithm with a sequence of observations, it will populate A, B, and π. It will not however help to consistently map signal strength fluctuations and variations in the list of candidates to the observation alphabet. If this mapping is not consistent across environments then the inferred hidden state may imply a different state of activity such as walking when the user is actually travelling in a motor car. To avoid an arduous data collection and calibration procedure an automated, unsupervised process is used to learn the mapping between signal strength fluctuation and variations in the list of candidates and the observation alphabet mapping. This process is described below.

Each different state of activity (in this example remaining stationary, walking and travelling in a motor car) to be distinguished produces a different pattern of signal strength fluctuation and candidate list variation. These patterns depend upon the environment. For example, there may be less signal strength fluctuation in a rural environment than in a metropolitan environment. By identifying the mean signal strength fluctuation value and the mean number of candidates appearing on the list of candidates for states of activity in specific environments, a mapping between these parameters and the observation alphabet can be determined. In the context of a HMM we use the distance from these means to discretise the continuous range of signal strength fluctuation and candidate list variation. Measurements that are close to the activity means indicate a stronger probability that the carrier is in a particular state of activity as opposed to those that, in terms of Euclidean distance, are positioned further away. Hence these levels of fluctuation are mapped to observations contained within the observation alphabet that reflect this likelihood.

In order to learn the levels of fluctuation a series of data points are collected in the environment to which the calibration setting relates. A data point comprises a candidate list variation measurement and a signal strength fluctuation measurement. Data points can be collected at random, that is, the carrier of the mobile communication device does not need to declare current activities.

In the context of tests that have been carried out, data was used from participants who engaged in all activities; walking, driving and remaining stationary. Participants were not asked to label the data. Instead, the data points were automatically partitioned into three sets, reflecting the three states of activities.

To partition the data, K-means can be used, with k=3, with the assumption that the participant will perform all three activities. If this is not the case then k can be adjusted to reflect this.

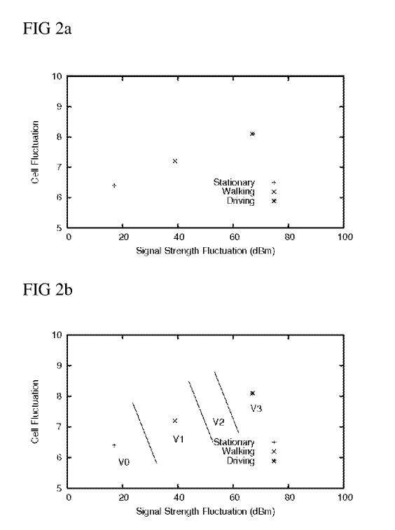

FIG. 2a shows the mean number of candidates appearing on the list of candidates and signal strength fluctuations, measured in an urban area on the outskirts of Bristol in the UK. In this figure the amount of variation of the candidate list and the signal strength fluctuation increase with the speed of the activities, that is, travelling in a motor car produces a greater level than walking, and walking a greater level than remaining stationary. Whilst this relationship is not linear, the positions of these means do lie along an approximately straight line. Approximately 85,000 measurements of cell and signal strength fluctuation from different areas of metropolitan and urban environments have been taken, and this behaviour has always been found to be consistent. That is, the activity means have typically lain along a straight line. The travelling in a car mean has on occasion been found to rise slightly above the line due to a proportionally greater level of variation in the candidate list. Perhaps the most useful aspect of the relationship between the means is that, in terms of Euclidean distance, the travelling in a motor car state of activity mean will always be greater than the walking state of activity mean and closer to the walking mean than the stationary mean and that the still mean will always be closer to and smaller than the walking mean. Hence, given the means produced by K-means, means can easily be matched to their corresponding states of activity. This approach would fail if travelling in a motor car produced less signal strength fluctuation or candidate list variation than walking or if remaining stationary produced a greater signal strength fluctuation or candidate list variation than walking. This “shortcut” is acceptable, however, because, extensive experiments in multiple heterogeneous environments have been conducted, and this situation has never been found to occur, nor is it expected to occur. This is due to the nature of GSM handoff strategies and the behaviour of signal strength fluctuation, i.e. travelling in a motor car creates a greater level of signal strength fluctuation than that created by remaining stationary.

Using the mean signal strength fluctuation and candidate list variation levels learnt for states of activity in a given environment it is possible to define mappings between GSM cell and signal measurements and the observation alphabet. It has been found that the best way to do this is by linearly separating the two-dimensional space defined by signal strength fluctuation and candidate list variation. The mean of two activity states in this two-dimensional space are calculated (for example a mean value S for the activity state stationary and a mean value W for the activity state walking), and these mean values in the space can be connected by a straight line. Equally-spaced lines, which are orthogonal to the line connecting the mean values, separate the two-dimensional space into a plurality of zones, with each of these zones representing a symbol in the observation alphabet.

An example of this is illustrated in FIG. 2b. Each zone created by slicing the measurement space represents a discrete subsection of the continuous measurement space. Hence each zone represents the membership criteria for an observation. Membership is determined by finding the zone in which a current measurement lies. In FIG. 2b, for clarity, just four observations have been superimposed (v₀, v₁, v₂, v₃). In practice any number of observations may be defined, with the measurement space being subdivided into a corresponding number of distinct zones. The greater the number of zones, the greater the accuracy of the result provided by the HMM. However, the greater the number of zones, the higher the computational overhead. It has been found that using 15 observations and dividing the measurement space into 15 zones represents an acceptable compromise between accuracy and computational overhead.

This approach to learning the optimum settings for a given environment avoids the need to relearn B. Instead the mapping between signal strength fluctuation and candidate list variation and the observation alphabet is updated. This allows consistent mappings between GSM measurements and the observation alphabet to be provided. This mapping reflects the probability of observations occurring in specific hidden states, matrix B. The alternative approach, relearning B, would require the use of fixed signal strength fluctuation and candidate list variation boundaries for mappings to observations. The probability of these observations occurring in specific states for a given environment would then need to be learnt. In order to learn these probabilities K-means would still need to be used to learn the activity state variances and means.

A disadvantage of this approach is that the discretised 2D space that represents the observation alphabet mappings needs to be exhaustive in order to operate in all types of environments. That is, the measurement space needs to be discretised in a manner fine enough to allow operation in environments with low levels of fluctuation as well as those with high levels such as metropolitan environments. This requires a much larger observation alphabet. This has a negative impact on the computational overhead of running the Viterbi algorithm to determine the most likely hidden state.

A supervised approach to creating a calibration setting for the algorithms is described below.

In order to calibrate an algorithm so that it is suitable for use in a given environment it is necessary to learn the levels of signal strength fluctuation and candidate list variation that are generated whilst undertaking activities such as walking and travelling in a motor car. In order to do this samples of signal strength fluctuation and candidate list variation must be collected whilst undertaking those activities. The combination of signal strength fluctuation and candidate list variation that is most likely to occur whilst undertaking those activities can then be learned.

In order to do this it is necessary to be able to identify when the carrier of the mobile communication device is undertaking the activities that it is desired to recognise. To do this the carrier can be asked to prompt when they are performing specific activities. For example, as the carrier leaves their house to drive to work the “travelling in a motor car” option on a training menu of the mobile communication device can be selected. By doing this the user is indicates to the activity recognition algorithm that they are now travelling in a motor car and the current cellular data can be used to learn the patterns of signal strength fluctuation and candidate list variation for travelling in a motor car.

Once training data has been collected for each tasks activity means can be calculated using the approach discussed earlier. After the mean signal strength fluctuation level and the mean number of candidates appearing on the list have been learnt for activities in a given environment the mappings between GSM cell and signal measurements and the observation alphabet can be defined. This process is described above (slicing the 2D measurement space up using the means and variances of the three activities along the two dimensions).

In an alternative approach, a GPS receiver can be used to identify activities such as walking, driving and remaining stationary. In this approach the speed at which that the carrier of the mobile communication device is moving, as reported by the GPS receiver, is mapped to a state of activity, i.e. slow speeds indicate walking and so on.

Once training data has been collected for each tasks activity means can be calculated using the approach discussed above. After the mean signal strength fluctuation level and the mean number of candidates appearing on the list have been learnt for activities in a given environment mappings between GSM cell and signal measurements, and the observation alphabet can be defined, using the process described above (slicing the 2D measurement space up using the means and variances of the three activities along the two dimensions).

Once a set of calibration settings has been created, parameters of a BTS monitored by the mobile communication device can be used to identify the type of environment in which it is operating, and thus select an appropriate calibration from the predetermined set. For example, a “Cell-ID” parameter associated with a BTS used in a GSM network contains a Location Area Code (LAC) in addition to other parameters such as a country code and an operator code. The LAC is used to group together cells distributed in the same environment. Large cities and other metropolitan areas are provisioned with multiple LACs, hence if the mobile communication device observes a large number of LACs during a time window it can infer that it is operating in a metropolitan environment, and thus retrieve and apply an appropriate calibration setting to the algorithm.

Alternatively, a look-up table can be provided containing a number of LACs with an indicator identifying the environment type in which the BTSs associated with each LAC operates. Thus, for example, a look up table might contain all of the LAC of a particular geographic area, such as a state, with each LAC being associated with an indicator of whether the BTSs associated with each LAC code operate in a metropolitan environment or in a rural environment. In such a system, an appropriate calibration setting for the algorithms can be selected by obtaining the LAC code of the BTS serving the mobile communication device and using it as an index to the look up table to identify the environment type in which the mobile communication device is operating, with an appropriate calibration setting then being selected and applied.

The methods described above can be used in mobile communication devices such as cell phones to improve the user experience, by adapting the behaviour of the device according to the state of activity of the carrier of the device. For example, calls can be automatically directed to an answer phone if the activity state of the carrier of the device is detected as travelling in a motor car, which might indicate that the carrier is driving. When the state of activity of the carrier is subsequently detected as stationary, an alert can be made to the carrier that they missed a call or that they have an answer phone message. Additionally or alternatively, the ring tone volume or period could be raised or extended or the vibration period lengthened depending upon the current state of activity. This would ensure that if the user was walking alerts would not be missed.

The state of running services can also be adapted depending upon the activity of the carrier of the cell phone. For example, services that are only used while the user is walking can safety be switched off when the user is stationary, and thus conserve power.

Although the example described above relates to a GSM network, the ‘handoff’ behaviour (or ‘handover’ behaviour, as it is also known) exists in all cellular networks due to the need to reuse frequencies. Hence this invention will work with CDMA, UMTS and other types of cellular networks.

Similarly, whilst the example above describes the use of signal strength measurements to calculate the total signal strength fluctuation, other parameters, such as signal to noise ratio or error rates, could also be used.

It will be apparent to those skilled in the relevant art that the methods described above can be implemented as software programs configured to cause a processor or processor system to implement the method. For example, the methods may be implemented as software applications to be installed and run on a cell phone. Equally, the methods may be implemented in hardware, in firmware loaded onto a device such as a Read-Only Memory, or on a specially configured IC, such as an ASIC.

Although the invention has been described above with reference to one or more preferred embodiments, it will be appreciated that various changes or modifications may be made without departing from the scope of the invention as defined in the appended claims.

1. A method of inferring a state of activity of a carrier of a mobile communication device, the method comprising:
a. monitoring a parameter of a transmitter serving the mobile communication device and of a plurality of neighbouring transmitters;
b. acquiring data relating to the monitored parameter of the serving transmitter and the neighbouring transmitters during a time window;
c. processing the acquired data to generate a time window parameter associated with the time window;
d. repeating steps b and c for one or more further time windows; and
e. inferring the state of activity of the carrier of the mobile communication device from the time window parameters generated in steps b and c.

2. A method according to claim 1 wherein the monitored parameter of the serving transmitter and the neighbouring transmitters comprises a signal strength associated with each of the transmitters.

3. A method according to claim 2 wherein the time window parameter comprises a total signal strength fluctuation value.

4. A method according to claim 3 wherein acquiring data relating to the monitored parameter comprises recording a signal strength value of the serving transmitter and each of the neighbouring transmitters at intervals during the time window.

5. A method according to claim 4 wherein processing the data acquired during the time window comprises
recording maximum and minimum signal strength values of the serving transmitter and each of the neighbouring transmitters;
calculating a transmitter signal strength fluctuation value of the serving transmitter and each of the neighbouring transmitters over the time window; and
calculating the total signal strength fluctuation value associated with the time window by summing the transmitter signal strength fluctuation values of the serving transmitter and the neighbouring transmitters.

6. A method according to claim 4 wherein recording the maximum and minimum signal strength values comprises
comparing the signal strength value of the serving transmitter and each of the neighbouring transmitters with previously recorded maximum and minimum signal strength values of that transmitter at each interval, and
if the signal strength value is greater than the previously recorded maximum signal strength value, recording the signal strength value as the maximum signal strength value;
if the signal strength value is smaller than the previously recorded minimum signal strength value, recording the signal strength value as the minimum signal strength value.

7. A method according to claim 4 wherein calculating the transmitter signal strength fluctuation of the serving transmitter and each of the neighbouring transmitters over the time window comprises subtracting the minimum signal strength value of each transmitter recorded during the time window from the maximum signal strength value of that transmitter recorded during the time window.

8. A method according to claim 1 wherein the monitored parameter of the serving transmitter and the neighbouring transmitters comprises an identifier associated with each transmitter.

9. A method according to claim 8 wherein acquiring data related to the monitored parameter comprises updating a list of a predetermined number of identifiers associated with candidate transmitters, the candidate transmitters being selected on the basis of their signal strength.

10. A method according to claim 9 wherein processing the acquired data comprises
calculating the number of separate identifiers which appear on the list during the time window.

11. An apparatus comprising a processor system configured to perform the method of claim 1.

12. A mobile communication device comprising an apparatus according to claim 11.

13. A program for causing a processor system to perform the method of claim 1.

14. A method of calibrating an algorithm for inferring a state of activity of a carrier of a mobile communication device, the method comprising
a. collecting data relating to a time window parameter associated with a transmitter serving the mobile communication device and a plurality of neighbouring transmitters;
b. grouping the collected data into a plurality of sets, each set reflecting a different state of activity;
c. calculating a mean for each set; and
d. using the calculated means to calibrate the algorithm.

15. A method according to claim 14 wherein the collected data are grouped automatically into the plurality of sets.

16. A method according to claim 14 further comprising collecting information relating to a state of activity of the carrier of the mobile communication device during collection of the data relating to the time window parameter, wherein the collected data are grouped according to the information so collected.

17. A method according to claim 16 wherein the information relating to the state of activity of the carrier comprises the movement speed of the carrier, each state of activity being associated with a range of movement speeds.

18. A method according to claim 16 wherein the information relating to the state of activity of the carrier comprises an identifier associated with the serving transmitter or the plurality of neighbouring transmitters.

19. A method according to claim 14 wherein the time window parameter comprises a total signal strength fluctuation of the serving cell and the neighbouring cells during a time window.

20. A method according to claim 14 wherein the time window parameter comprises a number indicative of the number of separate transmitter identifiers appearing on a list maintained by the mobile communication device during a time window.

21. A method according to claim 19 further comprising collecting data relating to a further time window parameter associated with the serving transmitter and the plurality of neighbouring transmitters.

22. A method according to claim 21 wherein the further time window parameter comprises a number indicative of the number of separate transmitter identifiers appearing on a list maintained by the mobile communication device during a time window.

23. An apparatus comprising a processor system configured to perform the method of claim 14.

23. A mobile telephone comprising an apparatus according to claim 23.

24. A program for causing a processor system to perform the method of claim 14.

25. A method of selecting a calibration setting for calibrating an algorithm for inferring a state of activity of a carrier of a mobile communication device, the selection method comprising observing a parameter of a transmitter serving a mobile communication device over a time window and using the parameter so observed to select a calibration setting from a pre-populated list of calibrations settings.

26. A method according to claim 25 further comprising inferring from the observed parameter an environment type and selecting a calibration setting appropriate to the environment type from the pre-populated list of calibration settings.
